(19) United States
(12) Patent Application Publication
(10) Pub. No.: US 2008/0235039 A1
(43) Pub. Date: Sep. 25, 2008

(54) ECONOMIC DEVELOPMENT SYSTEM AND METHOD

(76) Inventor: Ronald C. Stoll, Gulfport, FL (US)

Correspondence Address: MCKEE, VOORHEES & SEASE, P.L.C., 801 GRAND AVENUE, SUITE 3200, DES MOINES, IA, 50309-2721, US

(21) Appl. No.: 11/688,923

(22) Filed: Mar. 21, 2007

(51) Int. Cl. G06Q 10/00

(52) U.S. Cl. 705/1

(57) ABSTRACT

A consortium or professional employee organization (PEO) is used to assist in providing business support services to economic development clients. The consortium/PEO reports economic development data concerning the economic development clients to an economic development commission. The economic development commission ties the granting of economic development incentives to the use of the consortium/PEO.

### BACKGROUND OF THE PRESENT INVENTION

The present invention relates to economic development. More particularly, the present invention relates to providing services which support economic development in a manner that allows collection and analysis of economic development data, including the use of economic development funds.

Many cities, states, communities, or other organizations seeking economic development identify and provide incentives for Qualified Targeted Industries (QTI). Such incentives typically are provided to businesses in particular industries who begin operations, relocate or expand operations in a particular geographical location or area and whose presence will assist in job creation, providing quality wages to workers, adding to the tax basis, or otherwise assist in economic development in the geographical area. Often times, the incentives may include grants or tax incentives.

Despite the availability of incentives to assist with economic development, problems remain. One of the most significant problems relates to the cost and complexity of starting, expanding, or relocating a business. Such events are accompanied by significant need for human resources administration, payroll and tax processing, benefits processing, safety and worker compensation coverage, as well as other business support services. Typically a business is left to meet such needs on its own, which may be costly and time-consuming. Such problems may be especially acute for startup or emerging businesses which may have greater per employee expenses than

Another problem relates to the collection and analysis of data relating to economic development. Despite any reporting requirements that may be placed on economic development clients who receive incentives by the organization providing the incentives, problems remain in tracking the use of such incentives. In addition, because of the unavailability of meaningful and reliable data regarding economic development it is difficult to properly target the use of economic development funds. The availability of economic development funds is always limited, and economic development commissions are expected to act as responsible stewards of those funds. Yet, doing so is difficult as determining how best to use such funds is largely a subjective process. Such problems are further complicated as some of the potential economic development clients with the greatest potential, and the greatest need for economic development incentives, also have the greatest risk of failing.

What is needed is a method and system for providing services which support economic development in a manner that allows collection and analysis of economic development data, including the use of economic development funds.

### BRIEF SUMMARY

Therefore, it is a primary object, feature, or advantage of the present invention to improve upon the state of the art.

It is a further object, feature, or advantage of the present invention to provide a method and system that support economic development.

It is another object, feature, or advantage of the present invention to provide a method and system that assist in collection and analysis of economic data.

Yet another object, feature, or advantage of the present invention is to provide a method and system that assist in tracking the use of economic development funds.

A still further object, feature, or advantage of the present invention is to provide a method and system that allows economic development commission to assist economic development clients in ways in addition to or other than the direct providing of funds.

One or more of these and/or other objects, features, or advantages of the present invention will become apparent from the specification and claims that follow.

According to one aspect of the present invention, a method for tracking economic development activity is provided. The method includes providing business support services to a plurality of economic development clients to provide access to economic development data associated with the plurality of economic development clients and collecting economic development data associated with the plurality of economic development clients. The method further includes reporting the economic development data to an economic development commission. The economic development commission provides economic development incentives to the economic development clients either directly or indirectly.

According to another aspect of the present invention, a method for promoting effective use of economic development funding by economic development clients is provided. The method includes tying distribution of the economic funding to use of business support services provided through a single organization to the economic development clients and receiving from the single organization economic development data from the single organization about the economic development clients. The economic development data may include total quality improvement statistics including number of employees of each of the economic development clients, pay scale for employees of each of the economic development clients, and capital investment associated with each of the economic development clients.

According to yet another aspect of the present invention, a system for promoting effective use of economic development funding by economic development clients is provided. The system includes means for tying distribution of the economic funding to use of business support services provided through a single organization to the economic development clients and means for receiving from the single organization economic development data from the single organization about the economic development clients, wherein the economic development data comprises total quality improvement statistics including number of employees of each of the economic development clients, pay scale for employees of each of the economic development clients, and capital investment associated with each of the economic development clients.

### BRIEF DESCRIPTION OF THE DRAWINGS

FIG. 1 is an overview showing information flow associated with one embodiment of the present invention.

FIG. 2 is flowchart illustrating one embodiment of a method of the present invention.

### DETAILED DESCRIPTION OF EXEMPLARY EMBODIMENTS

The present invention is now explained in the context of exemplary embodiments. The present invention is not, however, to be limited to the specific embodiments shown and described.

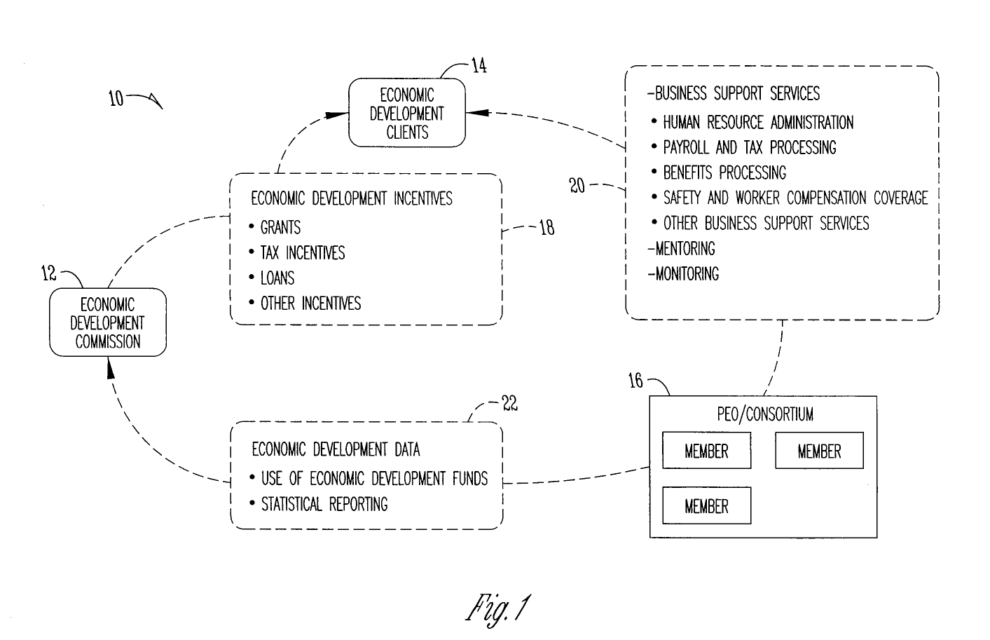

In FIG. 1, a system 10 is shown. The system 10 provides for promoting effective use of economic development incentives, such as, but not limited to economic development funding. The system 10 allows for economic development activity to be tracked or otherwise monitored, while at the same time providing economic development clients with needed business support services.

As shown in FIG. 1, the system 10 includes an economic development commission 12 or other organization responsible for promoting economic development. The economic development commission 12 assists economic development clients 14 by providing economic development incentives. The economic development incentives may include, without limitation, grants, tax incentives, loans, or other types of economic development incentives.

In FIG. 1, a professional employer organization (PEO) or consortium 16 is shown. The consortium 16 may include multiple member organizations. The purpose of the PEO/consortium 16 is to provide business support services 20 to economic development clients 14 while also providing economic development data 22 to the economic development commission 12. The consortium 16 may be a collaborative partnership of multiple companies or other members organized to provide complete packages of administrative support services designed to benefit both employers and employees. The result is resilient economic development in terms of employee services, attracting and retaining employees, employer profitability and efficient deployment of community resources. The business support services 20 of the consortium 16 provide total employee support services from recruiting and evaluation to payroll, mortgages, job descriptions, handbooks, insurance (group and voluntary), administrative systems, and regulatory compliances. The consortium 16 also is positioned to deliver third-party Qualified Targeted Industries reporting or other economic development data 22 to economic development commissions, a difficult task to accomplish for most commissions.

The consortium 16 is positioned to provide cost advantage to economic development clients 14. State unemployment rates, workers compensation rates, and insurance premiums are positively impacted for individual clients given the professional employer organization relationship that is the foundation of the consortium 16. Staffing fees may be deeply discounted in the consortium plan as well. Employees benefit from Section 125 and 401(k) provisions, voluntary benefits availability, decreased or forgiven banking fees, and professional human resources administration. A further, sometimes critical, component that the consortium 16 may provide is on-going mentoring of new, start-up or emerging firms served by economic development initiatives. Each consortium member preferably has regular contact with each economic development client 14 in the execution of their individual duties with the client. The consortium 16 preferably closely monitors the activities of the consortium members relative to each client 14. Thus, the business support services 20 may include human resource administration, payroll and tax processing, benefits processing, safety and worker compensation coverage, or other types of business support services. The business support services 20 may also include mentoring, monitoring, or other types of business support services that may assist the economic development clients in being successful.

The economic development data 22 may include information related to the use of economic development funds as well as statistical reporting. For example, the economic development data 22 may include the number of jobs created by each economic development client, the pay scale for the jobs created by each economic development client, the portion of a tax base attributable to each economic development client, as well as other data which provides insight into the economic impact of each economic development client. The economic development commission 12 may use this data in a number of ways. For example, the economic development commission 12 may use this data to evaluate the effects of the economic development incentives it provides, determine qualifying criteria for future economic development incentives, determine profiles of economic development clients most likelihood to result in greatest economic growth or most likely to meet other objectives.

It should be appreciated that the provision of business support services 20 to economic development clients 14 provides significant advantages to the economic development clients 14. The provision of business support services 20 to the economic development clients 14 using a PEO/consortium 16, allows the economic development commission 12 to assist the economic development clients 14 by selecting appropriate providers of business support services 20. The business support services 20 provided to the economic development clients 14 allow the economic development clients 14 to focus on growing their business while allowing trained individuals to provide for administration. Having a PEO provide business support services in a co-employee situation also potentially allows economic development clients 14 to provide its employees with benefits it might not be able to otherwise provide. This assists the economic development clients 14 in attracting and maintaining qualified employees.

Although the system 10 can be used in numerous situations for any number of types of economic development clients 14, one situation of interest is in assisting startup businesses, and especially technology-driven startup businesses. An economic development commission 12 may have a particular interest in assisting technology-driven startup businesses as technology-driven businesses are often associated with better educated, more highly paid employees. In addition, in technology-driven businesses, often there is the potential for fast growth rates. Also, in technology-driven startup businesses, often times the principals are not experienced in or interested in human resource administration, or other types of activities necessary for operation of a business.

Startup businesses may especially benefit from mentoring that may be provided by the PEO/consortium 16. The relationship between the PEO/consortium and the economic development clients 14 assists the economic development clients 14 in being successful. The greater the success of the economic development clients 14, the greater the success of the economic development commission 12 and the better the use of its economic development incentives.

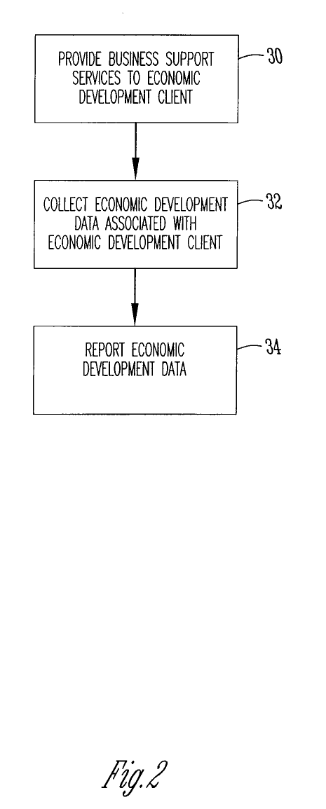

FIG. 2 is a flow chart illustrating one embodiment of a methodology. In FIG. 2, in step 30, business support services are provided to an economic development client. In step 32, economic development data associated with an economic development client is collected. In step 34, the economic development data is reported.

In operation of the system of FIG. 1 and the method shown in FIG. 2, the economic development commission 12 may retain the PEO/consortium 16 to provide services to economic development commission clients 14. The economic development commission retains the consortium or the PEO as an incentive to encourage the economic development client to locate and/or expand employment with specific definitions of employment type(s) and compensation. A contract may define the specific services provided. Reports tracking total quality improvement (TQI) statistics may be supplied to the economic development commission. The TQI statistics may include number of jobs created or maintained by economic development clients, the pay scale associated with the jobs created or maintained by the economic development clients, the capital investment made by the economic development clients, the employee benefits provided by the economic development clients, increase in the tax base attributable to economic development clients as well as other statistics regarding the economic effect of the economic development client.

The present invention contemplates that the business support services provided may be directly funded in whole or in part by the economic development commission 12. The PEO/consortium 16 may provide discounted rates, reduced rates, flat fee rates, or other special pricing to the economic development clients. Alternatively, the economic development clients 14 may directly pay the PEO/consortium 16 for the business support services provided. In such instances, the economic development commission may require the economic development clients to receive particular business support services from the PEO/consortium as a condition or contractual condition for obtaining the benefit of economic development incentives from the economic development commission.

A method and system has been provided that assists economic development efforts has been provided. It should be appreciated that the present invention contemplates numerous variations, alternatives, and options. The present invention is not to be limited to the specific disclosure provided herein.

What is claimed is:

1. A method for tracking economic development activity, comprising:
providing business support services to a plurality of economic development clients to provide access to economic development data associated with the plurality of economic development clients;
collecting economic development data associated with the plurality of economic development clients;
reporting the economic development data to an economic development commission;
wherein the economic development commission provides economic development incentives to the economic development clients.

2. The method of claim 1 wherein the economic development incentives include at least partial funding of the business support services.

3. The method of claim 1 wherein the business support services are provided by a professional employer organization.

4. The method of claim 1 wherein the business support services are provided by a consortium of member organizations, each member organization providing business support services to one or more of the economic development clients.

5. The method of claim 1 wherein the reporting comprises statistical reporting.

6. The method of claim 5 wherein the reporting comprises reporting of total quality improvement statistics.

7. The method of claim 1 wherein the business support services includes human resource administration services.

8. The method of claim 1 wherein the business support services include payroll and tax processing services.

9. The method of claim 1 wherein the business support services include benefits processing services.

10. A method for promoting effective use of economic development funding by economic development clients, comprising:
tying distribution of the economic funding to use of business support services provided through a single organization to the economic development clients;
receiving from the single organization economic development data from the single organization about the economic development clients, wherein the economic development data comprises total quality improvement statistics including number of employees of each of the economic development clients, pay scale for employees of each of the economic development clients, and capital investment associated with each of the economic development clients.

11. The method of claim 10 wherein the single organization is a professional employer organization.

12. The method of claim 10 wherein the single organization is a consortium of members.

13. The method of claim 10 wherein the steps of tying and receiving are performed by an economic development commission providing the economic funding to the economic development clients.

14. The method of claim 10 wherein the business support services includes human resource administration services.

15. The method of claim 10 wherein the business support services include payroll and tax processing services.

16. The method of claim 10 wherein the business support services include benefits processing services.

17. A system for promoting effective use of economic development funding by economic development clients, comprising:
means for tying distribution of the economic funding to use of business support services provided through a single organization to the economic development clients;
means for receiving from the single organization economic development data from the single organization about the economic development clients, wherein the economic development data comprises total quality improvement statistics including number of employees of each of the economic development clients, pay scale for employees of each of the economic development clients, and capital investment associated with each of the economic development clients.
